(19) United States
(12) Patent Application Publication
(10) Pub. No.: US 2003/0191017 A1
(43) Pub. Date: Oct. 9, 2003

(54) Olefin polymerization catalyst

(76) Inventors: Rinaldo Schiffino, Wilmington, DE (US); Alison Margaret Anne Bennett, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/118,790

(22) Filed: Apr. 9, 2002

(51) Int. Cl. B01J 31/00

(52) U.S. Cl. 502/155; 502/150; 502/152; 502/162; 502/167; 526/172

(57) ABSTRACT

An olefin polymerization catalyst component is prepared by making a solution of a transition metal complex of a selected tridentate ligand, adsorbing the complex onto a silica or silica-alumina support, and separating the solution from the supported transition metal complex component, which is storage stable. Olefin polymerizations with this component may be carried out with high catalyst productivity using cocatalysts such as trialkylaluminum compounds.

### FIELD OF THE INVENTION

This invention concerns an olefin polymerization catalyst which contains a transition metal complex of a selected tridentate ligand, a method for preparing such a catalyst, and an olefin polymerization process for utilizing such a catalyst.

### TECHNICAL BACKGROUND

Polyolefins are important items of commerce, and many such polymers are made using as part of the polymerization catalyst system a transition metal complex. Recently, there has been much interest in catalysts containing late transition metals, such as Fe, Co, Ni and Pd. One particular type of olefin polymerization catalyst contains what is believed to be a tridentate ligand which is a 2,6-pyridinedicarbox-aldehydebisimine or a 2,6-diacylpyridinebisimine or minor variation thereof, typically as an iron or cobalt complex. Such complexes and their use as olefin polymerization catalysts, especially ethylene polymerization catalysts, are described in U.S. Pat. No. 5,955,555, WO 9912981, WO 9946302, WO 9946303, WO 9946304, WO 0015646, WO 0024788, WO 0032641, WO 0050470, WO 0069869 and WO 0069923, all of which are hereby incorporated by reference for all purposes as if fully set forth.

Variations of these complexes have also found use as “polymerization” catalysts for the dimerization and oligomerization of ethylene and other alpha-olefins, to produce alpha-olefins and internal olefins. See, for example, U.S. Pat. No. 6,063,881, U.S. Pat. No. 6,103,946, WO 0055216 and WO 0073249, all of which are also incorporated by reference herein for all purposes as if fully set forth.

As with all olefin polymerization catalysts, an important consideration is the overall cost of the polymerization catalyst system per unit weight of polyolefin produced. Another important consideration is the form of the polymer product obtained, that is whether it is obtained in an easy to use form such as relatively nondusting particles which flow well and preferably have a relatively high bulk density, and whether fouling of the polymerization reactor(s) occurs.

Sometimes the main cost of the polymerization catalyst is not the transition metal complex itself, but the cost of preparing the catalyst and/or costs of other ingredients needed for the catalyst system. The latter is particularly true for many of the so-called single site catalysts such as metallocenes and many late transition metal-containing catalysts where aluminoxanes, especially methylaluminoxane, have been found to give superior results but are very expensive compared to other alkylaluminum compounds, thereby increasing the total catalyst system cost per unit weight of polyolefin produced.

This generally has been true with transition metal complexes of a 2,6-pyridinedicarboxaldehydebisimine or a 2,6-diacylpyridinebisimine, such as disclosed in the aforementioned incorporated references. Some exceptions have been noted, for example by modifying the surface of a support for a supported catalyst, see for instance WO 0020467, which is incorporated by reference herein for all purposes as if fully set forth. Although the modified support disclosed in this publication allows the use of alkylaluminum compounds other than aluminoxanes to achieve good polymerization results, modification of the support itself adds significantly to the overall polymerization catalyst cost per unit weight of polyolefin produced.

### SUMMARY OF THE INVENTION

This invention concerns, a process for the preparation of a supported polymerization catalyst component, comprising the steps of:

(a) dissolving a transition metal complex of a 2,6-pyridinedicarboxaldehydebisimine or a 2,6-diacylpyridinebisimine in a solvent to form a solution;

(b) contacting said solution with a support which is an unmodified silica or a silica-alumina for a sufficient amount of time to allow at least part of said metal complex to be adsorbed onto said support; and

(c) optionally separating said solution and solvent from said support;

provided that substantially no activator is present during steps (a), (b) and (c).

Also included in this invention is a catalyst obtainable or obtained by the above process.

This invention further includes a process for the polymerization of one or more polymerizable olefins, comprising the steps of:

(a) dissolving a transition metal complex of a 2,6-pyridinedicarboxaldehydebisimine or a 2,6-diacylpyridinebismine in an organic solvent to form a solution;

(b) contacting said solution with a support, which is a silica or a silica-alumina, for a sufficient amount of time to allow at least part of said metal complex to be adsorbed onto said support, thereby forming a supported catalyst component;

(c) optionally separating said solution and solvent from said supported catalyst component; and

(d) contacting, under polymerization conditions, said supported catalyst component with said one or more polymerizable olefins and one or more activators, provided that substantially no activator is present during steps (a), (b) and (c).

These and other features and advantages of the present invention will be more readily understood by those of ordinary skill in the art from a reading of the following detailed description. It is to be appreciated that certain features of the invention which are, for clarity, described below in the context of separate embodiments, may also be provided in combination in a single embodiment. Conversely, various features of the invention which are, for brevity, described in the context of a single embodiment, may also be provided separately or in any subcombination.

### DETAILED DESCRIPTION OF THE PREFERRED EMBODIMENTS

Herein certain terms are used. Some of them are:

A “hydrocarbyl group” is a univalent group containing only carbon and hydrogen. As examples of hydrocarbyls may be mentioned unsubstituted alkyls, cycloalkyls and aryls. If not otherwise stated, it is preferred that hydrocarbyl groups herein contain 1 to about 30 carbon atoms.

By “substituted hydrocarbyl” herein is meant a hydrocarbyl group that contains one or more (types of) substituents that do not substantially interfere with the operation of the polymerization catalyst system. Suitable substituents in some polymerizations may include some or all of halo, ester, keto (oxo), amino, imino, carboxyl, phosphite, phosphonite, phosphine, phosphinite, thioether, amide, nitrile, and ether. Preferred substituents when present are halo, ester, amino, imino, carboxyl, phosphite, phosphonite, phosphine, phosphinite, thioether, and amide. Which substituents are useful in which polymerizations may in some cases be determined by reference to the previously incorporated publications (for example U.S. Pat. No. 5,955,555), as well as U.S. Pat. No. 5,880,241 which is also incorporated by reference herein for all purposes as if fully set forth. If not otherwise stated, it is preferred that substituted hydrocarbyl groups herein contain 1 to about 30 carbon atoms. Included in the meaning of “substituted” are chains or rings containing one or more heteroatoms, such as nitrogen, oxygen and/or sulfur, and the free valence of the substituted hydrocarbyl may be to the heteroatom. In a substituted hydrocarbyl, all of the hydrogens may be substituted, as in trifluoromethyl.

By “(inert) functional group” herein is meant a group other than hydrocarbyl or substituted hydrocarbyl that is, other than participating in “adsorption” (defined below) of the complex on the support, inert under the process conditions to which the compound containing the group is subjected. The functional groups also do not substantially interfere with any process described herein that the compound in which they are present may take part in. Examples of functional groups include halo (fluoro, chloro, bromo and iodo), and ether such —OR³⁰ wherein R³⁰ is hydrocarbyl or substituted hydrocarbyl. In cases in which the functional group may be near a transition metal atom (such as an iron atom), the functional group should not coordinate to the transition metal atom more strongly than the groups in those compounds which are shown as coordinating to the transition metal atom, that is they should not displace the desired coordinating groups.

“Alkyl group” and “substituted alkyl group” have their usual meaning (see above for substituted under substituted hydrocarbyl). Unless otherwise stated, alkyl groups and substituted alkyl groups preferably have 1 to about 30 carbon atoms.

By “aryl” is meant a monovalent aromatic group in which the free valence is to the carbon atom of an aromatic ring. An aryl may have one or more aromatic rings which may be fused, connected by single bonds or other groups.

By “substituted aryl” is meant a monovalent aromatic group substituted as set forth in the above definition of “substituted hydrocarbyl”. Similar to an aryl, a substituted aryl may have one or more aromatic rings which may be fused, connected by single bonds or other groups; however, when the substituted aryl has a heteroaromatic ring, the free valence in the substituted aryl group can be to a heteroatom (such as nitrogen) of the heteroaromatic ring instead of a carbon.

By an “activator”, “cocatalyst” or a “catalyst activator” is meant one or more compounds that react with a transition metal compound to form a catalyst species that can polymerize the polymerizable olefin(s). Useful activators include alkylaluminum compounds, certain boron compounds, and other alkylating or hydriding compounds. Typically the transition metal compound used in the first process, and in steps (a), (b) and (c) of the second process will not by itself start a polymerization, but will require the use of one or more activators to make an active olefin polymerization catalyst.

By “substantially no activator is present” is meant that no activator is present other than, for example, at very low levels as might be typical for impurities in the various components. The intention is that no significant amounts of activated catalyst species are generated in the supportation process by the interaction of the transition metal complex with an activator—this activation should preferably occur at or close to the time the catalyst is used in a polymerization process.

By an “unmodified” support (silica or silica-alumina) is meant a support that does not contain (either bonded or simply on the surface) materials which are designed to bond or otherwise cause the transition metal complex to adhere to the support. Such materials include alkylaluminum compounds and other alkylating and hydriding compounds, Lewis acids (bound or unbound to the surface of the support), and other similar compounds. Preferably the transition metal complex, and more preferably the tridentate ligand therein, does not have bonded to it a group which will or may react with the support to covalently bond to that support. For example it is preferred that the ligand does not contain a hydroxyl (alcohol) group which reacts with the silica surface.

By an “alkylaluminum compound” is meant a compound which has at least one alkyl group bound directly to aluminum. Other groups such as, for example, alkoxide, hydride and halogen, may also be bound to aluminum atoms in the compound. Alkylaluminum compounds are activators.

By a “silica” or silica-alumina” is meant a silica or a silica-alumina that may or may not have been dehydrated, as by heating. Preferably the material has been dehydrated to some extent, preferably by heating, before taking part in any of the processes described herein. These materials are well known in the art of polymer catalyst supports, and often, and preferably have high porosity and/or surface area. They often also have a small and/or controlled particle size.

By “polymerization” is meant, in its broadest context, to include dimerization, oligomerization and polymerization (both homopolymerization and copolymerization).

By “polymerization conditions” herein is meant conditions for causing olefin “polymerization” with catalysts using the same transition metal tridentate complexes, modified as described herein. In other words the polymerization catalyst systems described herein may be used under the same conditions as previously reported for the same complexes. Such conditions may include temperature, pressure, suspending media, polymerization method such as gas phase, liquid phase, continuous, batch, and the like. Supported catalysts are particularly useful in liquid suspension polymerizations and gas phase polymerizations.

By “adsorbed” herein is merely meant that a first substance is “attracted” to a second substance so that so that the first substance “sticks” to the second substance (at least in part) even though for example the adsorbed first substance may be in the presence of a solvent for that first substance. The word “adsorbed” herein has no connotation as to why the first substance sticks to the second substance.

By “relatively noncoordinating” (or “weakly coordinating”) anions are meant those anions as are generally referred to in the art in this manner, and the coordinating ability of such anions is known and has been discussed in the literature, see for instance W. Beck., et al., Chem. Rev., vol. 88 p. 1405-1421 (1988), and S. H. Stares, Chem. Rev., vol. 93, p. 927-942 (1993), both of which are hereby incorporated by reference herein for all purposes as if fully set forth. Among such anions are those formed from the aluminum compounds in the immediately preceding paragraph and X⁻, including R⁹₃AlX⁻, R⁹₂AlClX⁻, R⁹AlCl₂X⁻, and “R⁹AlOX⁻”, wherein R⁹ is alkyl. Other useful noncoordinating anions include BAF⁻ {BAF=tetrakis[3,5-bis(trifluoromethyl)-phenyl]borate}, SbF₆⁻, PF₆⁻, and BF₄⁻, trifluoromethanesulfonate, p-toluenesulfonate, (R_{f}SO₂)₂N⁻, and (C₆F₅)₄B⁻.

By a “tridentate” ligand is meant a ligand that is capable of being a tridentate ligand, that is it has three sites, often heteroatom sites, that can coordinate to a transition metal atom simultaneously. Preferably all three sites do coordinate to the transition metal.

By a “primary carbon group” herein is meant a group of the formula —CH₂—, wherein the free valence—is to any other atom, and the bond represented by the solid line is to a ring atom of a substituted aryl to which the primary carbon group is attached. Thus the free valence—may be bonded to a hydrogen atom, a halogen atom, a carbon atom, an oxygen atom, a sulfur atom, etc. In other words, the free valence—may be to hydrogen, hydrocarbyl, substituted hydrocarbyl or a functional group. Examples of primary carbon groups include —CH₃, —CH₂CH(CH₃)₂, —CH₂Cl, —CH₂C₆H₅, —OCH₃ and —CH₂OCH₃.

By a “secondary carbon group” is meant the group

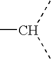

wherein the bond represented by the solid line is to a ring atom of a substituted aryl to which the secondary carbon group is attached, and both free bonds represented by the dashed lines are to an atom or atoms other than hydrogen. These atoms or groups may be the same or different. In other words the free valences represented by the dashed lines may be hydrocarbyl, substituted hydrocarbyl or inert functional groups. Examples of secondary carbon groups include —CH(CH₃)₂, —CHCl₂, —CH(C₆H₅)₂, cyclohexyl, —CH(CH₃)OCH₃, and —CH═CCH₃.

By a “tertiary carbon group” is meant a group of the formula

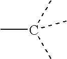

wherein the bond represented by the solid line is to a ring atom of a substituted aryl to which the tertiary carbon group is attached, and the three free bonds represented by the dashed lines are to an atom or atoms other than hydrogen. In other words, the bonds represented by the dashed lines are to hydrocarbyl, substituted hydrocarbyl or inert functional groups. Examples of tetiary carbon groups include —C(CH₃)₃, —C(C₆H₅)₃, —CCl₃, —CF₃, —C(CH₃)₂OCH₃, —C≡CH, —C(CH₃)₂CH═CH₂, aryl and substituted aryl such as phenyl and 1-adamantyl.

Preferred 2,6-pyridinedicarboxaldehydebisimines and 2,6-diacylpyridinebisimine are compounds of the formula (I)

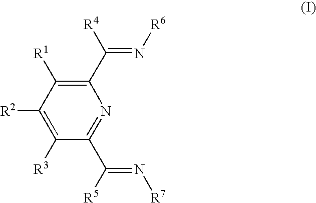

wherein:

R¹, R², R³, R⁴ and R⁵ are each independently hydrogen, hydrocarbyl, substituted hydrocarbyl or an inert functional group, provided that any two of R¹, R² and R³ vicinal to one another, taken together may form a ring; and

R⁶ and R⁷ are aryl, substituted aryl or a functional group.

Typically a transition metal complex of (I) will have the formula LMXₘYₙ wherein L is the 2,6-pyridinedicarboxal-dehydebisimine or a 2,6-diacylpyridinebisimine ligand, M is the transition metal, X is a monoanion (one negative charge), Y is a relatively noncoordinating monoanion, and m+n is equal to the oxidation state of M. Typically if all of X are monodentate anions, then n is zero, and m is equal to the oxidation state of M. If for example one of X is a bidentate monoanion, then usually n is one (if m+n is 2). Therefore m may be an integer of 1 or more, while n may be 0 or an integer of 1 or more, preferably n is 0 or 1.

Monodentate monoanions include halide and carboxylate, while bidentate monoanions include acetylacetonate, allylic and benzylic monoanions. Relatively noncoordinating anions are defined above.

When neither X nor Y are a hydrocarbyl anion or hydride, typically to form an active polymerization (in the second process) at least X must be converted to a hydrocarbyl anion such as alkyl or hydride (other anions may also be active). This is usually achieved with an activator (cocatalyst) which can, for example, alkylate the metal. By “alkylate” herein is meant the cocatalyst reacts with LMXₘYₙ to alkylate the metal (for example to give LM(alkyl)ₘYₙ), while optionally at the same time forming a relatively noncoordinating anion by abstracting one of the alkyl groups (especially if n is zero). “Hydriding” is analogous to alkylating, except using a hydride anion instead of an alkyl anion. Alternatively, as part of the catalyst system a second cocatalyst which is a neutral Lewis acid may be added to abstract the alkyl group and form a relatively noncoordinating anion. Note that this is just one scenario to form an active olefin polymerization catalyst that can be used, depending on the particular metal complex used and the cocatalyst(s) used.

Preferably, the activator (cocatalyst) is either (1) a neutral Lewis acid which is both (i) capable of abstracting an anion from said transition metal of said transition metal complex to form a weakly coordinating anion, and (ii) capable of alkylating or hydriding said transition metal; or (2) a combination of (i) a neutral Lewis acid which is capable of abstracting an anion from said transition metal of said transition metal complex to form a weakly coordinating anion, and (ii) another compound which is capable of alkylating or hydriding said transition metal. More preferably, the cocatalyst is an alkylating compound and a Lewis acid which can form a weakly coordinating anion.

Useful alkylating compounds include alkylaluminum compounds (which can also be hydriding compounds if they contain hydrogen bound to aluminum), alkylzinc compounds, and Grignard reagents. Preferred compounds which can both alkylate and form a relatively noncoordinating anion are alkylaluminum compounds such as trialkylaluminum compounds including trimethylaluminum, triethylaluminum, tri-n-butylaluminum and tri-i-butylaluminum; alkylhaloaluminum compounds such as diethylaluminum chloride, ethylaluminum chloride and ethylaluminum sesquichloride; and (alkoxy)(alkyl)aluminum compounds such as ethoxydiethylaluminum. Aluminoxanes, such as methylaluminoxane, may also be used, but because of their cost (even though they may be very effective otherwise) they are not preferred.

In (I) it is generally preferred that:

R¹, R² and R³ are hydrogen; and/or R¹ and R³ are hydrogen, and R² is trifluoromethyl; and/or

R⁴ and R⁵ are each independently halogen, thioalkyl, hydrogen or alkyl containing 1 to 6 carbon atoms, more preferably R⁴ and R⁵ are each independently hydrogen or methyl.

In one preferred form of (I), R⁶ and R⁷ are each independently a substituted aryl and, more preferably, a substituted phenyl. Still more preferably, R⁶ is

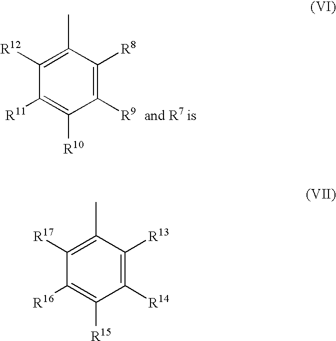

wherein:

R⁸, R¹², R¹³ and R¹⁷ are each independently hydrocarbyl, substituted hydrocarbyl or an inert functional group;

R⁹, R¹⁰, R¹¹, R¹⁴, R¹⁵ and R¹⁶ are each independently hydrogen, hydrocarbyl, substituted hydrocarbyl or an inert functional group;

and provided that any two of R⁸, R⁹, R¹⁰, R¹¹, R¹², R¹³, R¹⁴, R¹⁵, R¹⁶ and R¹⁷ that are vicinal to one another, taken together may form a ring.

In (VI) and (VII), it is preferred that:

R⁹, R¹⁰, R¹¹, R¹⁴, R¹⁵ and R¹⁶ are each independently hydrogen, halogen, or an alkyl containing 1 to 6 carbon atoms, and more preferably that each of these is hydrogen; and/or

R¹⁰ and R¹⁵ are methyl, phenyl or substituted phenyl (such as an alkyl substituted phenyl); and/or

R⁸, R¹², R¹³ and R¹⁷ are each independently halogen, phenyl, substituted phenyl or an alkyl containing 1 to 6 carbon atoms, more preferably that each is independently phenyl, substituted phenyl (e.g., an alkyl substituted phenyl such as p-t-butylphenyl) or an alkyl containing 1-6 carbon atoms (such as i-propyl or t-butyl) (although it is not preferred when both R⁸ and R¹², or both R¹³ and R¹⁷, are t-butyl in the same compound).

Specific preferred compounds are (in combination with any of the variants for R¹, R², R³, R⁴ and R⁵ mentioned above) where R⁶ and R⁷ are, respectively, (VI) and (VII), and:

R⁹, R¹¹, R¹⁴ and R¹⁶ are hydrogen, and R⁸, R¹⁰, R¹², R¹³, R¹⁵ and R¹⁷ are methyl;

R⁹, R¹⁰, R¹¹, R¹⁴, R¹⁵ and R¹⁶ are hydrogen, R⁸ and R¹³ are chloro, and R¹² and R¹⁷ are methyl;

R⁹, R¹⁰, R¹¹, R¹⁴, R¹⁵, R¹⁶ and R¹⁷ are hydrogen, and R⁸ and R¹³ are phenyl;

R⁹, R¹⁰, R¹¹, R¹⁴, R¹⁵, R¹⁶ and R¹⁷ are hydrogen, and R⁸ and R¹³ are p-t-butylphenyl;

R⁹, R¹⁰, R¹¹, R¹⁴, R¹⁵ and R¹⁶ are hydrogen, and R⁸, R¹², R¹³ and R¹⁷ are phenyl;

R⁹, R¹⁰, R¹¹, R¹⁴, R¹⁵ and R¹⁶ are hydrogen, and R⁸, R¹², R¹³ and R¹⁷ are p-t-butylphenyl;

R⁹, R¹⁰, R¹¹, R¹⁴, R¹⁵ and R¹⁶ are hydrogen, and R⁸ and R¹³ are phenyl, and R¹² and R¹⁷ are halo;

R⁹, R¹⁰, R¹¹, R¹⁴, R¹⁵ and R¹⁶ are hydrogen, and R⁸ and R¹³ are p-t-butylphenyl, and R¹² and R¹⁷ are halo;

R⁹, R¹⁰, R¹¹, R¹⁴, R¹⁵ and R¹⁶ are hydrogen, and R⁸, R¹², R¹³ and R¹⁷ are i-propyl; and

R⁹, R¹⁰, R¹¹, R¹², R¹⁴, R¹⁵, R¹⁶ and R¹⁷ are hydrogen, and R⁸ and R¹³ are t-butyl.

In another preferred variant of (I), R⁶ and R⁷ are each independently a substituted 1-pyrroyl. More preferably in this instance, R⁶ and R⁷ are, respectively

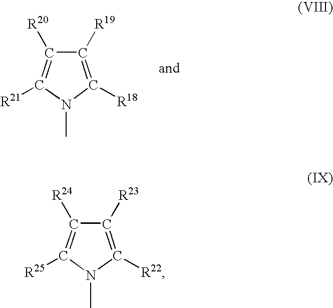

wherein:

R¹⁸ and R²¹ correspond to the definitions of, and preferences for, R⁸ and R¹² in (VI);

R²² and R²⁵ correspond to the definitions of, and preferences for, R¹³ and R¹⁷ in (VII);

R¹⁹ and R²⁰ correspond to the definitions of, and preferences for, R⁹ and R¹¹ in (VI); and

R²³ and R²⁴ correspond to the definitions of, and preferences for, R¹⁴ and R¹⁶ in (VII).

In “polymerizations” in which a dimer or oligomer is produced, R⁶ and R⁷ are preferably each independently a substituted aryl having a first ring atom bound to the imino nitrogen, provided that:

in R⁶, a second ring atom adjacent to said first ring atom is bound to a halogen, a primary carbon group, a secondary carbon group or a tertiary carbon group; and further provided that

in R⁶, when said second ring atom is bound to a halogen or a primary carbon group, none, one or two of the other ring atoms in R⁶ and R⁷ adjacent to said first ring atom are bound to a halogen or a primary carbon group, with the remainder of the ring atoms adjacent to said first ring atom being bound to a hydrogen atom; or

in R⁶, when said second ring atom is bound to a secondary carbon group, none, one or two of the other ring atoms in R⁶ and R⁷ adjacent to said first ring atom are bound to a halogen, a primary carbon group or a secondary carbon group, with the remainder of the ring atoms adjacent to said first ring atom being bound to a hydrogen atom; or

in R⁶, when said second ring atom is bound to a tertiary carbon group, none or one of the other ring atoms in R⁶ and R⁷ adjacent to said first ring atom are bound to a tertiary carbon group, with the remainder of the ring atoms adjacent to said first ring atom being bound to a hydrogen atom;

By a “first ring atom in R⁶ and R⁷ bound to an imino nitrogen atom” is meant the ring atom in these groups bound to an imino nitrogen shown in (I), for example

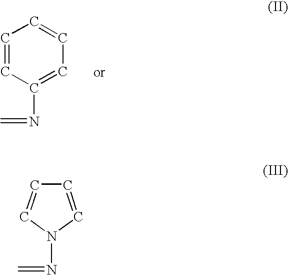

the atoms shown in the 1-position in the rings in (II) and (III) are the first ring atoms bound to an imino carbon atom (other groups which may be substituted on the aryl groups are not shown). Ring atoms adjacent to the first ring atoms are shown, for example, in (IV) and (V), where the open valencies to these adjacent atoms are shown by dashed lines (the 2,6-positions in (IV) and the 2,5-positions in (V)).

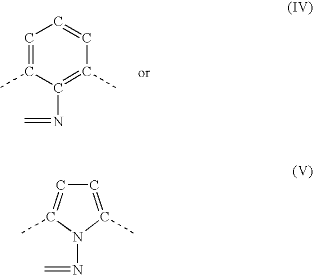

In preferred dimerization/oligomerization embodiments, R⁶ is

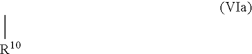

and R⁷ is

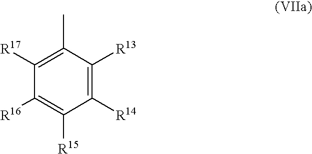

wherein:

R⁸ is a halogen, a primary carbon group, a secondary carbon group or a tertiary carbon group; and

R⁹, R¹⁰, R¹¹, R¹⁴, R¹⁵, R¹⁶ and R¹⁷ are each independently hydrogen, hydrocarbyl, substituted hydrocarbyl or a functional group;

provided that:

when R⁸ is a halogen or primary carbon group none, one or two of R¹², R¹³ and R¹⁷ are a halogen or a primary carbon group, with the remainder of R¹², R¹³ and R¹⁷ being hydrogen; or

when R⁸ is a secondary carbon group, none or one of R¹², R¹³ and R¹⁷ is a halogen, a primary carbon group or a secondary carbon group, with the remainder of R¹², R¹³ and R¹⁷ being hydrogen; or

when R⁸ is a tertiary carbon group, none or one of R¹², R¹³ and R¹⁷ is tertiary carbon group, with the remainder of R¹², R¹³ and R¹⁷ being hydrogen;

and further provided that any two of R⁸, R⁹, R¹⁰, R¹¹, R¹², R¹³, R¹⁴, R¹⁵, R¹⁶ and R¹⁷ vicinal to one another, taken together may form a ring.

In the above formulas (VIa) and (VIIa), R⁸ corresponds to the second ring atom adjacent to the first ring atom bound to the imino nitrogen, and R¹², R¹³ and R¹⁷ correspond to the other ring atoms adjacent to the first ring atom.

In compounds (I) containing (VIa) and (VIIa), it is particularly preferred that:

if R⁸ is a primary carbon group, R¹³ is a primary carbon group, and R¹² and R¹⁷ are hydrogen; or

if R⁸ is a secondary carbon group, R¹³ is a primary carbon group or a secondary carbon group, more preferably a secondary carbon group, and R¹² and R¹⁷ are hydrogen; or

if R⁸ is a tertiary carbon group (more preferably a trihalo tertiary carbon group such as a trihalomethyl), R¹³ is a tertiary carbon group (more preferably a trihalotertiary group such as a trihalomethyl), and R¹² and R¹⁷ are hydrogen; or

if R⁸ is a halogen, R¹³ is a halogen, and R¹² and R¹⁷ are hydrogen.

In all specific preferred compounds (I) in which (VIa) and (VIIa) appear, it is preferred that R¹, R² and R³ are hydrogen; and/or R⁴ and R⁵ are methyl. It is further preferred that:

R⁹, R¹⁰, R¹¹, R¹², R¹⁴, R¹⁵, R¹⁶ and R¹⁷ are all hydrogen; R¹³ is methyl; and R⁸ is a primary carbon group, more preferably methyl; or

R⁹, R¹⁰, R¹¹, R¹², R¹⁴, R¹⁵, R¹⁶ and R¹⁷ are all hydrogen; R¹³ is ethyl; and R⁸ is a primary carbon group, more preferably ethyl; or

R⁹, R¹⁰, R¹¹, R¹², R¹⁴, R¹⁵, R¹⁶ and R¹⁷ are all hydrogen; R¹³ is isopropyl; and R⁸ is a primary carbon group, more preferably isopropyl; or

R⁹, R¹⁰, R¹¹, R¹², R¹⁴, R¹⁵, R¹⁶ and R¹⁷ are all hydrogen; R¹³ is n-propyl; and R⁸ is a primary carbon group, more preferably n-propyl; or

R⁹, R¹⁰, R¹¹, R¹², R¹⁴, R¹⁵, R¹⁶ and R¹⁷ are all hydrogen; R¹³ is chloro; and R⁸ is a halogen, more preferably chloro; or

R⁹, R¹⁰, R¹¹, R¹², R¹⁴, R¹⁵, R¹⁶ and R¹⁷ are all hydrogen; R¹³ is trihalomethyl, more preferably trifluoromethyl; and R⁸ is a trihalomethyl, more preferably trifluoromethyl.

In another preferred embodiment of (I), R⁶ and R⁷ are, respectively

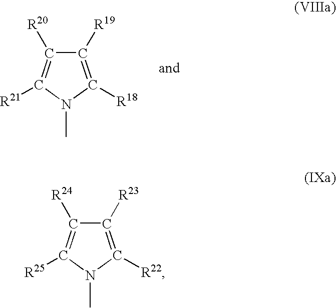

wherein:

R¹⁸ corresponds to the definitions of, and preferences for, R⁸ (VIa);

R¹⁹, R²⁰ and R²¹ correspond respectively to the definitions of, and preferences for, R⁹, R¹⁰ and R¹² in (VIa); and

R²², R²³, R²⁴ and R²⁵ correspond respectively to the definitions of, and preferences for, R¹³, R¹⁴, R¹⁶ and R¹⁷ in (VIIa).

In the above formulas (VIIIa) and (IXa), R¹⁸ corresponds to the second ring atom adjacent to the first ring atom bound to the imino nitrogen, and R²¹, R²² and R²⁵ correspond to the other ring atoms adjacent to the first ring atom.

Any transition metal which forms an active polymerization catalyst with (I) may be used. As examples of suitable transition metal may be mentioned those found in Groups 3-12 of the Periodic Table (IUPAC). Preferred are the Groups 8-10 transition metals, more preferred are the Groups 8 and 9 transition metals, particularly preferred are Fe and Co, and Fe is especially preferred.

Compound (I) and its transition metal complexes may be prepared by the variety of methods disclosed in the previously incorporated references, as well as by the procedures disclosed, for example, in WO 9950273 and WO 00/08034, both of which are also incorporated by reference herein for all purposes as if fully set forth.

Preferred monomers for polymerization (including oligomerization) are ethylene and alpha-olefins of the formula R¹⁸CH═CH₂ wherein R¹⁸ is n-alkyl, especially n-alkyl containing 1 to 10 carbon atoms. Preferred is ethylene alone to give an ethylene homopolymer (or in the case of oligomerization, a series of alpha-olefins having an even number of carbon atoms), or a combination of ethylene with one or more alpha-olefins (such as propylene, 1-hexene, 1-octene, 1-decene and/or 1-dodecene) to give an ethylene copolymer.

In the processes of the present invention (both preparing the supported catalyst component and polymerization of one or more olefins), the transition metal complex is preferably initially dissolved in a solvent. It is preferred that the solvent not substantially decompose the complex, although the solvent may additionally complex with the metal complex. Preferably the solvent is an aprotic solvent, and not a protic solvent such as water, an alcohol or a carboxylic acid. Preferably, the complex should have a solubility of at least about 0.0001 g per 100 ml of solvent, more preferably at least about 0.01 g per 100 ml of solvent.

Preferably, the solvent/complex combination is then brought into contact with the silica or silica-alumina (collectively, the support), preferably under agitation, at which point the complex becomes at least partially adsorbed on the support. Adsorption may be relatively fast, particularly if the complex has a relatively high solubility in the solvent. In this case the contacting may be done for less than 1 hour. If the complex has a low solubility in the solvent (for example not all the transition metal may dissolve at once), more time (perhaps about 10 hours or more) may be needed to dissolve the complex and have it adsorbed onto the support. Mild agitation to ensure mixing of the support with the solution is preferred. Oftentimes the complex is colored, and one can judge the progress of the adsorption of the complex onto the support visually. Sometimes not all the transition metal complex will be adsorbed onto the support. It is preferable that at least about 50%, more preferably at least about 80% of the complex present is adsorbed. Unadsorbed complex may be recycled to be adsorbed onto more support.

After the contacting stage, the solution and/or solvent may be separated from the support (and adsorbed complex) by any standard method, for example filtering off the support from the solvent (and any still complex dissolved therein), or centrifuging the mixture and decanting the supernatant away from the solid, the solvent removed by evaporation, for example under vacuum. Preferably the solution is separated from the support as a liquid, as by filtration or centrifuging as described above. If desired the support and adsorbed complex may be washed with solvent to remove any unadsorbed complex (some adsorbed complex may also be removed at this point), and/or the support and adsorbed complex may be dried, as by vaporization under vacuum. However preferably the majority, preferably >90%, of the solvent should not be separated from the supported complex by vaporizing the solvent (in other words a physical separation of the solid support and the liquid solvent (solution) should be carried out). The supported catalyst may also be used in a polymerization process without separating it from the solvent/solution, but it is preferred that it is separated from the solvent/solution before use in a polymerization.

Preferably the ratio of transition metal complex to support in step (a) will be such that the final amount of transition metal on the supported catalyst (measured as transition metal) is about 0.01 to about 5.0, more preferably about 0.02 to about 1.0 weight percent of the total weight of the supported catalyst component. Small amounts of experimentation may be needed to determine the exact conditions necessary to obtain a particular concentration of transition metal in the supported catalyst component, with any particular set of transition metal complex, solvent and support; however, this experimentation is well within the capability of a person of ordinary skill in the art. Generally speaking the higher the ratio of transition metal complex to support which is present in the first process, the greater the amount of transition metal in the supported catalyst component.

In order to ensure that the supported catalyst is as active as possible it is preferred that all steps (and storage) in which the transition metal complex is present (unadsorbed or adsorbed) be carried out under an inert atmosphere such as nitrogen or argon.

It has been found that the supported catalyst component made by this procedure is stable at room temperature for extended periods. Also this catalyst need not contain materials that are considered flammable or pyrophoric, and it may be shipped without extraordinary precautions by relatively cheap means.

This supported catalyst component can be used as part of a catalyst system for the polymerization of olefins, as disclosed in the various previously incorporated publications.

In the polymerization process described above, a preferred molar ratio of the alkylating or hydriding cocatalyst (preferably an alkylaluminum compound or a dialkylzinc compound) to “moles” of transition metal is about 1 to about 2000, more preferably about 5 to about 1000, and especially preferably about 30 to about 500 (any of these minimum and maximum ratios may be paired with each other). Typically this cocatalyst is also simultaneously used as a scavenger, that is a chemical compound which removes impurities in the polymerization system which are deleterious to the polymerization process. Thus the ratio of this cocatalyst to transition metal will also depend to some extent on the level of deleterious impurities in the second process.

If an additional Lewis acid is need to abstract, say, an alkyl, and form a relatively noncoordinating anion, generally speaking the molar ratio of this Lewis acid to transition metal is typically about 1 to about 5.

It is preferred that any cocatalysts used in the polymerization process contact the supported catalyst made in the first process in the presence of olefin monomer(s), or the contacting with the cocatalysts be carried out shortly before (less than 6 hours, more preferably less than 1 hour, and especially preferably less than 5 minutes) additionally contacting with the olefin monomer(s). Indeed it is especially preferred that the cocatalyst(s) and supported catalyst be contacted together in the polymerization vessel itself, or in a process line leading to the polymerization vessel. If the polymerization process takes place in liquid phase, for example a suspension polymerization, the supported catalyst and any cocatalyst(s) can be added to the suspending liquid medium. If the polymerization is a gas phase polymerization the particulate supported catalyst may be fluidized by the gas and the cocatalyst(s) such as a trialkylaluminum compound may be added as a vapor. For this purpose a relatively volatile alkylaluminum compound such as trimethylaluminum is often favored.

More than one transition metal compound may be used as the polymerization catalyst, one or both may be supported on the same support or a different support. For more information on such mixed catalysts, see previously incorporated WO 9946302, as well as WO 9838228, WO 9950318 and WO 9957159, all of which are also incorporated by reference herein for all purposes as if fully set forth. Typical polymerization conditions may be used, for example, hydrogen may be used to control the molecular weight of the polyolefin. See, for example, previously incorporated WO 9946302, as well as WO 9962963 which is also incorporated by reference herein for all purposes as if fully set forth.

In one preferred form of the polymerization process, the transition metal complex of the tridentate ligand oligomerizes ethylene to relatively pure α-olefins. For information on such oligomerizations see, for example, previously incorporated U.S. Pat. No. 6,063,881, U.S. Pat. No. 6,103,946, WO 0055216 and WO 0073249, as well as WO 0076659 which is also incorporated by reference for all purposes as if fully set forth. If in addition a second transition metal compound which is capable of copolymerizing ethylene and a-olefins is also present, a branched polyethylene will be obtained. See, for example, previously incorporated WO 9950318 and WO 0055216. In this instance it is preferred that the second transition metal compound is on the same support as is used in the first process, and the oligomerization and polymerization catalysts may be placed on the support simultaneously (as in the first process, with the additional polymerization catalyst also present).

The morphology of the silica particles used as the support is often replicated in the polymer particles (including silica) obtained. The product of many of the Examples below show such replication. The replication of the silica support morphology is believed to show a uniform deposition of the catalyst species in the absence of any deposited activating aluminum alkyl compound, such as methylaluminoxane.

In the Examples and Experiment the following abbreviations are used:

acac—acetylacetonate

ICP—Inductively Coupled Plasma Spectroscopy

r.b.—round bottomed

THF—tetrahydrofuran

In the Examples, all pressures are gauge pressures. In the Examples the following transition metal complexes are used:

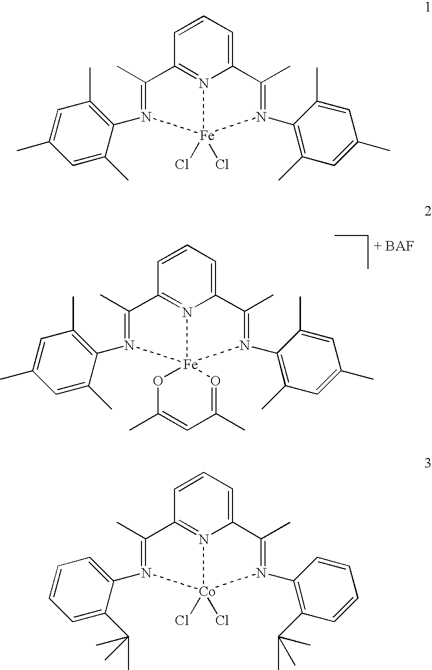

1 and 3 were made by procedures described in previously incorporated U.S. Pat. No. 5,955,555.

### EXAMPLE 1

1 was recrystallized from CH₂Cl₂. 1 (7.0 mg) was dissolved in anhydrous CH₂Cl₂ (7 ml) and silica (0.5 g, Grace dehydrated 948 silica, Grade XPO-2402, dehydrated to 1 mmole OH group per gram of silica) was added. The resulting deep blue mixture was agitated for 30 min. The resulting solid was then filtered from the very pale blue filtrate, and dried. Yield 0.5 g light blue solid. Mass % Fe (ICP)=0.14%.

### EXAMPLE 2

1 was recrystallized from CH₂Cl₂. 1 (7.0 mg) was dissolved in anhydrous CH₂Cl₂ (7 ml) and silica alumina [0.5 g, Grace M513-1.10 dehydrated at 200° C. (flowing N₂)] was added. The resulting deep blue mixture was agitated for 60 min. The resulting solid was then filtered from the colorless filtrate, washed with CH₂Cl₂ and dried. Yield 0.5 g light blue/grey solid.

### EXAMPLE 3

1 was recrystallized from CH₂Cl₂. 1 (7.0 mg) was dissolved in anhydrous CH₂Cl₂ (7 ml) and silica alumina [0.5 g, Grace M513-1.10 dehydrated at 500° C. (flowing N₂)] was added. The resulting deep blue mixture was agitated for 60 min. The resulting solid was then filtered from the colorless filtrate, washed with CH₂Cl₂ and dried. Yield 0.5 g light orange solid.

### EXAMPLE 4

1 was recrystallized from CH₂Cl₂. 1 (4.0 mg) was dissolved in anhydrous toluene (15 ml) and silica (0.25 g, Grace XPO-2402 dehydrated 948 silica) was added. The resulting mixture was agitated overnight. The resulting solid was then filtered from the almost colorless filtrate, washed with toluene and pentane and dried. Yield 0.5 g light blue solid.

### EXAMPLE 5

1, not recrystallized, (4.0 mg) was dissolved in anhydrous toluene (15 ml) and silica (0.25 g, Grace XPO-2402 dehydrated 948 silica) was added. The resulting mixture was agitated overnight. The resulting solid was then filtered from the almost colorless, washed with toluene and pentane and dried. Yield 0.5 g light blue solid.

### EXPERIMENT 1

2 was prepared by weighing (C₂₇H₃₁N₃, 1.00 g, 397.56 g/mol, 2.515 mmol) and Fe(acac)₂ (644 mg, 253.15 g/mol, 2.516 mmol) and [Na][BAF] (2.24 g, 890 g/mol, 2.517 mmol, BAF=B[3,5-(CF₃)₂C₆H₂]₄) into a vial and then placing in a 50 ml r.b. flask with a stir bar. THF (25 ml) was added to give a dark red solution which was stirred for 24 h. THF was removed (product is not completely soluble in THF), and the product suspended in toluene and filtered through Celite®. The solvent was removed from the dark red solution, pentane added to give a red precipitate which was filtered, rinsed and dried under vacuum to give 2.

Elemental Analysis for: C₆₄H₅₀BF₂₄FeN₃O₂ (1415.72 g/mol), Theoretical: C, 54.30; H, 3.56; N, 2.97. Experimental result: C, 54.37; H, 3.58; N, 2.96.

### EXAMPLE 6

2 (19.6 mg) was dissolved in anhydrous toluene (7 ml) to give an orange-yellow solution, and silica alumina [0.5 g, Grace dehydrated at 200° C. (flowing N₂)] was added. The resulting mixture was agitated for 60 min. The solid was then filtered from the almost colorless filtrate, washed with toluene and pentane and dried. Yield 0.5 g light orange/beige solid.

### EXAMPLE 7

3 (7.5 mg) was dissolved in anhydrous CH₂Cl₂ (7 ml) to form a bright yellow solution, and silica (0.5 g, Grace dehydrated 948 silica) was added. The resulting mixture was agitated for 60 min. The solid was then filtered from the pale yellow filtrate, washed with toluene and pentane and dried. Yield 0.5 g lemon yellow solid.

### EXAMPLE 8

In a dry box, a stainless cylinder (25 to 40 ml volume) were charged with the product of Example 1 (75.8 mg) and another cylinder with 10 ml of a solution of triisobutylaluminum (1 M solution in hexane, Aldrich). The cylinders were connected to the autoclave reactor ports under nitrogen purge of the connections. Cylinder pressurization lines were also connected under purge.

Isobutane (1200 g, Matheson C.P. grade) was transferred into a cooled autoclave (−30° C.) by pressure difference. Once the transfer was completed, the autoclave (Autoclave Engineers, agitated, 1-gal, 3.8 L) was heated to 20° C. and stirred at 1000 rpm. The solvent was saturated with hydrogen at a pressure of 0.36 MPa (total pressure, including hydrogen). After saturation, the reactor was heated to 80° C. and pressurized with ethylene to 1.4 MPa. The triisobutylaluminum solution was pushed into the reactor with ethylene followed by the catalyst from Example 1, also pushed with ethylene. The final reactor pressure was 2.41 MPa and the ethylene feed was switched from the feed vessels to the side port in the autoclave. The reaction was run for 3 h. At the end of the polymerization, the reactor was vented slowly, followed by a nitrogen purge prior to opening of the reactor. The polymer was dried overnight. The polymer yield was 353 g, resulting in a catalyst efficiency of 4.65 kg PE/g catalyst (including support), or a polymerization rate of 1.55 kg PE/g catalyst·h or 1109 kg PE/g Fe·h.

### EXAMPLE 9

Following the same procedure as in Example 8, but with 5 ml of triisobutylaluminum solution and 75.5 mg of supported catalyst from Example 1, the polymer yield was 316 g, resulting in a catalyst efficiency of 4.18 kg PE/g Catalyst, or a polymerization rate of 1.40 kg PE/g catalyst·h or 997 kg PE/g Fe·h.

### EXAMPLE 10

Following the same procedure as in Example 8, but with 15 ml of triisobutylaluminum solution and 78.0 mg of supported catalyst from Example 1, the polymer yield was 256 g, resulting in a catalyst efficiency of 3.28 kg PE/g Catalyst, or a polymerization rate of 1.09 kg PE/g catalyst·h or 781 kg PE/g Fe·h.

### EXAMPLE 11

Following the same procedure as in Example 8, but with 10 ml of triisobutylaluminum solution and 75.8 mg of supported catalyst from Example 2, the polymer yield was 182 g, resulting in a catalyst efficiency of 2.4 kg PE/g catalyst, or a polymerization rate of 0.8 kg PE/g catalyst·h or 572 kg PE/g Fe·h.

### EXAMPLE 12

Following the same procedure as in Example 8, but with 10 ml of triisobutylaluminum solution and 74.2 mg of the supported catalyst of Example 4, the polymer yield was 380 g, resulting in a catalyst efficiency of 5.12 kg PE/g catalyst, or a polymerization rate of 1.71 kg PE/g catalyst·h or 1219 kg PE/g Fe·h.

### EXAMPLE 13

Following the same procedure as in Example 8, but with 10 ml of triisobutylaluminum solution and 75.4 mg of the supported catalyst of Example 4, the polymer yield was 374 g, resulting in a catalyst efficiency of 4.96 kg PE/g catalyst, or a polymerization rate of 1.65 kg PE/g catalyst·h or 1181 kg PE/g Fe·h.

### EXAMPLE 14

Following the same procedure as in Example 8, but with 5 ml of triisobutylaluminum solution and 79.8 mg of the supported catalyst of Example 3, the polymer yield was 51 g, resulting in a catalyst efficiency of 0.64 kg PE/g catalyst, or a polymerization rate of 0.21 kg PE/g catalyst·h or 152 kg PE/g Fe·h.

### EXAMPLE 15

1 (7.0 mg) was weighted into a scintillation vial and dissolved in about 10 ml of toluene, and 0.5 g of silica gel (Grace Davidson 948) dehydrated to 0.76 mmol OH/g was added to the vial. The vial was shaken for 30 min. The mixture was filtered through a course glass frit and the solids were dried overnight in vacuum at room temperature.

### EXAMPLES 16-28

Following the same procedure as in Example 8, but using the catalyst made in Example 15 at different hydrogen resulted in the polymer yields shown below in the table.

| | | Cat. | Yield | Activity | |
|---|---|---|---|---|---|
| Example | Hydrogen | Wt. | dry | Kg PE/g | Bulk |
| Number | kPag | mg | g | Fe/hr | Density |
| 16 | 125 | 80.0 | 88.0 | 282 | 0.316 |
| 17 | 35 | 78.2 | 32.0 | 105 | |
| 18 | 35 | 73.9 | 234.0 | 812 | 0.316 |
| 19 | 276 | 72.3 | 19.0 | 67 | |
| 20 | 125 | 76.2 | 232.0 | 781 | 0.3097 |
| 21 | — | 74.9 | 260.0 | 890 | 0.404 |
| 22 | 35 | 75.5 | 154.0 | 523 | 0.304 |
| 23 | 125 | 75.2 | 174.0 | 593 | 0.313 |
| 24 | 245 | 76.1 | 118.0 | 398 | 0.289 |
| 25 | 572 | 76.9 | 31.0 | 103 | 0.259 |
| 26 | 125 | 79.9 | 273.0 | 876 | 0.325 |
| 27 | 207 | 76.7 | 230.0 | 769 | 0.319 |
| 28 | 69 | 75.0 | 400.0 | 1368 | 0.367 |

What is claimed is:

1. A process for the preparation of a supported polymerization catalyst component, comprising the steps of:
(a) dissolving a transition metal complex of a 2,6-pyridinedicarboxaldehydebisimine or a 2,6-diacylpyridinebisimine in a solvent to form a solution;
(b) contacting said solution with a support which is an unmodified silica or a silica-alumina for a sufficient amount of time to allow at least part of said metal complex to be adsorbed onto said support; and
(c) optionally separating said solution and solvent from said support;
provided that substantially no activator is present during steps (a), (b) and (c).

2. The process of claim 1, wherein step (b) is conducted under agitation.

3. The process of claim 1, wherein the transition metal complex has the formula LMXₘYₙ wherein L is the 2,6-pyridinedicarboxaldehydebisimine or a 2,6-diacylpyridine-bisimine ligand, M is the transition metal, X is a monoanion, Y is a relatively noncoordinating monoanion, and m+n is equal to the oxidation state of M.

4. The process of claim 3, wherein the ligand has the formula (I) 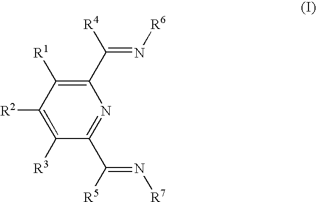
wherein:
R¹, R², R³, R⁴ and R⁵ are each independently hydrogen, hydrocarbyl, substituted hydrocarbyl or an inert functional group, provided that any two of R¹, R² and R³ vicinal to one another, taken together may form a ring; and
R⁶ and R⁷ are aryl, substituted aryl or a functional group.

5. The process of claim 4 wherein:
R¹, R² and R³ are hydrogen, or R¹ and R³ are hydrogen, and R² is trifluoromethyl;
R⁴ and R⁵ are each independently hydrogen or methyl; 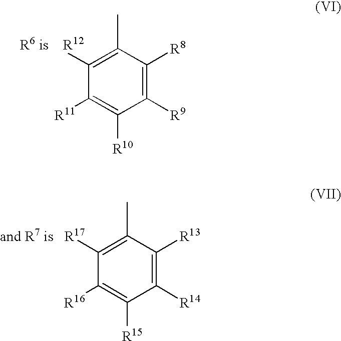
wherein:
R⁸, R¹², R¹³ and R¹⁷ are each independently hydrocarbyl, substituted hydrocarbyl or an inert functional group;
R⁹, R¹⁰, R¹¹, R¹⁴, R¹⁵ and R¹⁶ are each independently hydrogen, hydrocarbyl, substituted hydrocarbyl or an inert functional group;
and provided that any two of R⁸, R⁹, R¹⁰, R¹¹, R¹², R¹³, R¹⁴, R¹⁵, R¹⁶ and R¹⁷ that are vicinal to one another, taken together may form a ring.

6. The process of claim 5 wherein:
R¹, R², and R³ are hydrogen;
R⁴ and R⁵ are hydrogen or methyl;
R⁹, R¹¹, R¹⁴ and R¹⁶ are hydrogen, and R⁸, R¹⁰, R¹², R¹³, R¹⁵ and R¹⁷ are methyl; or
R⁹, R¹⁰, R¹¹, R¹⁴, R¹⁵ and R¹⁶ are hydrogen, R⁸ and R¹³ are chloro, and R¹² and R¹⁷ are methyl; or
R⁹, R¹⁰, R¹¹, R¹⁴, R¹⁵, R¹⁶ and R¹⁷ are hydrogen, and R⁸ and R¹³ are phenyl; or
R⁹, R¹⁰, R¹¹, R¹⁴, R¹⁵, R¹⁶ and R¹⁷ are hydrogen, and R⁸ and R¹³ are p-t-butylphenyl; or
R⁹, R¹⁰, R¹¹, R¹⁴, R¹⁵ and R¹⁶ are hydrogen, and R⁸, R¹², R¹³ and R¹⁷ are phenyl; or
R⁹, R¹⁰, R¹¹, R¹⁴, R¹⁵ and R¹⁶ are hydrogen, and R⁸, R¹², R¹³ and R¹⁷ are p-t-butylphenyl; or
R⁹ R¹⁰, R¹¹, R¹⁴, R¹⁵ and R¹⁶ are hydrogen, and R⁸ and R¹³ are phenyl, and R¹² and R¹⁷ are halo; or
R⁹, R¹⁰, R¹¹, R¹⁴, R¹⁵ and R¹⁶ are hydrogen, and R⁸ and R¹³ are p-t-butylphenyl, and R¹² and R¹⁷ are halo; or
R⁹, R¹⁰, R¹¹, R¹⁴, R¹⁵ and R¹⁶ are hydrogen, and R⁸, R¹², R¹³ and R¹⁷ are i-propyl; or
R⁹, R¹⁰, R¹¹, R¹², R¹⁴, R¹⁵, R¹⁶ and R¹⁷ are hydrogen, and R⁸ and R¹³ are t-butyl.

7. The process of claim 4 wherein:
R¹, R² and R³ are hydrogen, or R¹ and R³ are hydrogen, and R² is trifluoromethyl;
R⁴ and R⁵ are each independently hydrogen or methyl; 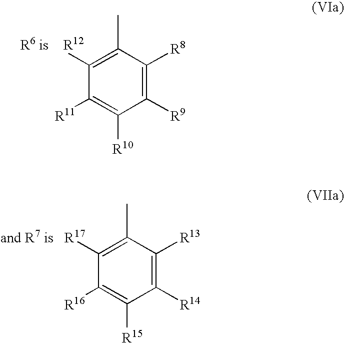
wherein:
R⁸ is a halogen, a primary carbon group, a secondary carbon group or a tertiary carbon group; and
R⁹, R¹⁰, R¹¹, R¹⁴, R¹⁵, R¹⁶ and R¹⁷ are each independently hydrogen, hydrocarbyl, substituted hydrocarbyl or a functional group;
provided that:
when R⁸ is a halogen or primary carbon group none, one or two of R¹², R¹³ and R¹⁷ are a halogen or a primary carbon group, with the remainder of R¹², R¹³ and R¹⁷ being hydrogen; or
when R⁸ is a secondary carbon group, none or one of R¹², R¹³ and R¹⁷ is a halogen, a primary carbon group or a secondary carbon group, with the remainder of R¹², R¹³ and R¹⁷ being hydrogen; or
when R⁸ is a tertiary carbon group, none or one of R¹²₁ R¹³ and R¹⁷ is tertiary carbon group, with the remainder of R¹², R¹³ and R¹⁷ being hydrogen;
and further provided that any two of R⁸, R⁹, R¹⁰, R¹¹, R¹², R¹³, R¹⁴, R¹⁵, R¹⁶ and R¹⁷ vicinal to one another, taken together may form a ring.

8. The process of claim 7 wherein:
R⁹, R¹⁰, R¹¹, R¹², R¹⁴, R¹⁵, R¹⁶ and R¹⁷ are all hydrogen, and R¹³ and R⁸ are methyl; or
R⁹, R¹⁰, R¹¹, R¹², R¹⁴, R¹⁵, R¹⁶ and R¹⁷ are all hydrogen, and R⁸ and R¹³ are ethyl; or
R⁹, R¹⁰, R¹¹, R¹², R¹⁴, R¹⁵, R¹⁶ and R¹⁷ are all hydrogen and R⁸ and R¹³ are isopropyl; or
R⁹, R¹⁰, R¹¹, R¹², R¹⁴, R¹⁵, R¹⁶ and R¹⁷ are all hydrogen, and R⁸ and R¹³ are n-propyl; or
R⁹, R¹⁰, R¹¹, R¹², R¹⁴, R¹⁵, R¹⁶ and R¹⁷ are all hydrogen, and R⁸ and R¹³ are chloro; or
R⁹, R¹⁰, R¹¹, R¹², R¹⁴, R¹⁵, R¹⁶ and R¹⁷ are all hydrogen, and R⁸ and R¹³ are trifluoromethyl.

9. A polymerization catalyst component obtained by the process of claim 1.

10. A process for the polymerization of one or more polymerizable olefins, comprising the steps of:
(a) dissolving a transition metal complex of a 2,6-pyridinedicarboxaldehydebisimine or a 2,6-diacylpyridinebisimine in an organic solvent to form a solution;
(b) contacting said solution with a support, which is a silica or a silica-alumina, for a sufficient amount of time to allow at least part of said metal complex to be adsorbed onto said support, thereby forming a supported catalyst component;
(c) optionally separating said solution and solvent from said supported catalyst component; and
(d) contacting, under polymerization conditions, said supported catalyst component with said one or more polymerizable olefins and one or more activators,
provided that substantially no activator is present during steps (a), (b) and (c).

11. The process of claim 6, wherein step (b) is conducted under agitation.

12. The process of claim 6, wherein the transition metal complex has the formula LMXₘYₙ wherein L is the 2,6-pyridinedicarboxaldehydebisimine or a 2,6-diacylpyridine-bisimine ligand, M is the transition metal, X is a monoanion, Y is a relatively noncoordinating monoanion, and m+n is equal to the oxidation state of M.

13. The process of claim 7, wherein the ligand has the formula (I) 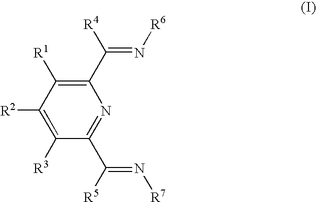
wherein:
R¹, R², R³, R⁴ and R⁵ are each independently hydrogen, hydrocarbyl, substituted hydrocarbyl or an inert functional group, provided that any two of R¹, R² and R³ vicinal to one another, taken together may form a ring; and
R⁶ and R⁷ are aryl, substituted aryl or a functional group.

14. The process of claim 12 wherein:
R¹, R² and R³ are hydrogen, or R¹ and R³ are hydrogen, and R² is trifluoromethyl;
R⁴ and R⁵ are each independently hydrogen or methyl; 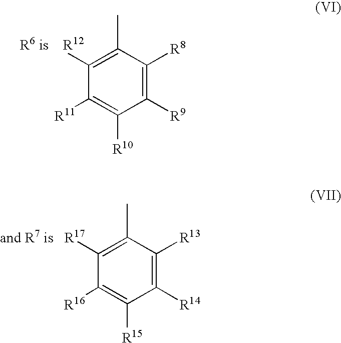
wherein:
R⁸, R¹², R¹³ and R¹⁷ are each independently hydrocarbyl, substituted hydrocarbyl or an inert functional group;
R⁹, R¹⁰, R¹¹, R¹⁴, R¹⁵ and R¹⁶ are each independently hydrogen, hydrocarbyl, substituted hydrocarbyl or an inert functional group;
and provided that any two of R⁸, R⁹, R¹⁰, R¹¹, R¹², R¹³, R¹⁴ R¹⁵, R¹⁶ and R¹⁷ that are vicinal to one another, taken together may form a ring.

15. The process of claim 13 wherein:
R¹, R², and R³ are hydrogen;
R⁴ and R⁵ are hydrogen or methyl;
R⁹, R¹¹, R¹⁴ and R¹⁶ are hydrogen, and R⁸, R¹⁰, R¹², R¹³, R¹⁵ and R¹⁷ are methyl; or
R⁹, R¹⁰, R¹¹, R¹⁴₁ R¹⁵ and R¹⁶ are hydrogen, R⁸ and R¹³ are chloro, and R¹² and R¹⁷ are methyl; or
R⁹, R¹⁰, R¹¹, R¹⁴, R¹⁵, R¹⁶ and R¹⁷ are hydrogen, and R⁸ and R¹³ are phenyl; or
R⁹, R¹⁰, R¹¹, R¹⁴, R¹⁵, R¹⁶ and R¹⁷ are hydrogen, and R⁸ and R¹³ are p-t-butylphenyl; or
R⁹, R¹⁰, R¹¹, R¹⁴, R¹⁵ and R¹⁶ are hydrogen, and R⁸, R¹², R¹³ and R¹⁷ are phenyl; or
R⁹, R¹⁰, R¹¹, R¹⁴, R¹⁵ and R¹⁶ are hydrogen, and R⁸, R¹², R¹³ and R¹⁷ are p-t-butylphenyl; or
R⁹, R¹⁰, R¹¹, R¹⁴, R¹⁵ and R¹⁶ are hydrogen, and R⁸ and R¹³ are phenyl, and R¹² and R¹⁷ are halo; or
R⁹, R¹⁰, R¹¹, R¹⁴, R¹⁵ and R¹⁶ are hydrogen, and R⁸ and R¹³ are p-t-butylphenyl, and R¹² and R¹⁷ are halo; or
R⁹, R¹⁰, R¹¹, R¹⁴, R¹⁵ and R¹⁶ are hydrogen, and R⁸, R¹², R¹³ and R¹⁷ are i-propyl; or
R⁹, R¹⁰, R¹¹, R¹², R¹⁴, R¹⁵, R¹⁶ and R¹⁷ are hydrogen, and R⁸ and R¹³ are t-butyl.

16. The process of claim 12 wherein:
R¹, R² and R³ are hydrogen, or R¹ and R³ are hydrogen, and R² is trifluoromethyl;
R⁴ and R⁵ are each independently hydrogen or methyl; 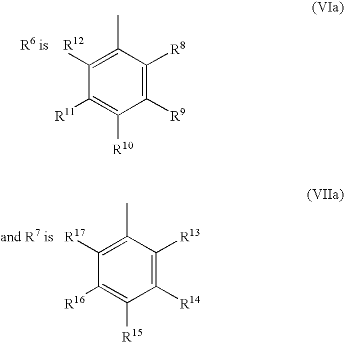
wherein:
R⁸ is a halogen, a primary carbon group, a secondary carbon group or a tertiary carbon group; and
R⁹, R¹⁰, R¹¹, R¹⁴, R¹⁵, R¹⁶ and R¹⁷ are each independently hydrogen, hydrocarbyl, substituted hydrocarbyl or a functional group;
provided that:
when R⁸ is a halogen or primary carbon group none, one or two of R¹², R¹³ and R¹⁷ are a halogen or a primary carbon group, with the remainder of R¹², R¹³ and R¹⁷ being hydrogen; or
when R⁸ is a secondary carbon group, none or one of R¹², R¹³ and R¹⁷ is a halogen, a primary carbon group or a secondary carbon group, with the remainder of R¹², R¹³ and R¹⁷ being hydrogen; or
when R⁸ is a tertiary carbon group, none or one of R¹², R¹³ and R¹⁷ is tertiary carbon group, with the remainder of R¹², R¹³ and R¹⁷ being hydrogen;
and further provided that any two of R⁸, R⁹, R¹⁰, R¹¹, R¹², R¹³, R¹⁴, R¹⁵, R¹⁶ and R¹⁷ vicinal to one another, taken together may form a ring.

17. The process of claim 15 wherein:
R⁹, R¹⁰, R¹¹, R¹², R¹⁴, R¹⁵, R¹⁶ and R¹⁷ are all hydrogen, and R¹³ and R⁸ are methyl; or
R⁹, R¹⁰, R¹¹, R¹², R¹⁴, R¹⁵, R¹⁶ and R¹⁷ are all hydrogen, and R⁸ and R¹³ are ethyl; or
R⁹, R¹⁰, R¹¹, R¹², R¹⁴, R¹⁵, R¹⁶ and R¹⁷ are all hydrogen and R⁸ and R¹³ are isopropyl; or
R⁹, R¹⁰, R¹¹, R¹², R¹⁴, R¹⁵, R¹⁶ and R¹⁷ are all hydrogen, and R⁸ and R¹³ are n-propyl; or
R⁹, R¹⁰, R¹¹, R¹², R¹⁴, R¹⁵, R¹⁶ and R¹⁷ are all hydrogen, and R⁸ and R¹³ are chloro; or
R⁹, R¹⁰, R¹¹, R¹², R¹⁴, R¹⁵, R¹⁶ and R¹⁷ are all hydrogen, and R⁸ and R¹³ are trifluoromethyl.
